(19) United States
(12) Patent Application Publication
(10) Pub. No.: US 2024/0218186 A1
(43) Pub. Date: Jul. 4, 2024

(54) METHOD OF PREPARING COATED PIGMENT AND WATER-BASED INK COMPOSITION CONTAINING COATED PIGMENT PREPARED THEREBY

(71) Applicant: DONG-A PENCIL CO., LTD., Daejeon (KR)

(72) Inventors: Jin Hee SHIN, Daejeon (KR); Jungju EOM, Daejeon (KR); Nara JO, Daejeon (KR); Jung Gul AN, Daejeon (KR)

(73) Assignee: DONG-A PENCIL CO., LTD., Daejeon (KR)

(21) Appl. No.: 18/351,918

(22) Filed: Jul. 13, 2023

(30) Foreign Application Priority Data
Dec. 28, 2022 (KR) 10-2022-0187492

(51) Int. Cl. C09C 3/08; C09D 11/17; C09D 11/18

(52) U.S. Cl. CPC C09C 3/08; C09D 11/17; C09D 11/18

(57) ABSTRACT

Proposed are a method of preparing a coated pigment, which includes: preparing a pigment dispersion by mixing and dispersing first and second surfactants with a pigment in water; and coating the pigment by adding an emulsion obtained by mixing and emulsifying a polymerizable surfactant and first and second monomers that differ in glass transition point, to the pigment dispersion, a water-based ink composition containing a thickener and the coated pigment prepared thereby, and a water-based writing instrument including the ink composition. When preparing the coated pigment by the above method, there are advantages of improving pigment dispersion stability and adsorption stability of a coating layer while controlling hardness and flexibility due to the glass transition point difference. In addition, when using the coated pigment as an ink pigment, adhesiveness and lubricity can be improved while providing a better writing experience.

### CROSS REFERENCE TO RELATED APPLICATION

The present application claims priority to Korean Patent Application No. 10-2022-0187492, filed Dec. 28, 2022, the entire contents of which is incorporated herein for all purposes by this reference.

### BACKGROUND OF THE DISCLOSURE

### 1. Field of the Disclosure

The present disclosure relates to a method of preparing a coated pigment and a water-based ink composition containing the coated pigment prepared thereby. More specifically, the present disclosure relates to a method of preparing a coated pigment using two different types of surfactants as pigment dispersants and two different monomers that differ in glass transition point by a value of at least 50° C. as pigment-coating agents, to a water-based ink composition containing the coated pigment prepared thereby, and to a water-based writing instrument including the water-based ink composition.

### 2. Description of the Related Art

In Egypt around 4000 B.C., a reed filled with ink was known as the first pen, and in the 6th century B.C., the nib of a quill made with the wing feathers of large birds, such as a goose or swan, was dipped in ink for use. Then, in the late 19th century, a fountain pen with a cartridge responsible for storing ink was known to be mainly used. Although fountain pens are advantageous in terms of portability, a problem of ink smudging occurs frequently. As a result, writing instruments for replacing fountain pens began to be developed. In the 1940s, when American companies manufacturing writing instruments started to mass-produce ballpoint pens, ballpoint pens became popular.

These ballpoint pens are mainly classified into oil-based ballpoint pens and water-based ballpoint pens according to the types of solvent used for ink manufacturing. In the case of an oil-based ballpoint pen using ink based on a high-boiling solvent, the ink moves only when in contact with a rolling ball. For this reason, when the rolling ball is unstable, there are problems in that pen skipping and line splitting occur easily, and ink blobs, so-called ink build-ups, are likely to be generated during writing. A water-based ballpoint pen, in which ink based on water and a water-soluble organic solvent is used, has been developed for solving the problems in oil-based ballpoint pens. The water-based ballpoint pen uses water as a solvent. Thus, when simply making the tip of the ballpoint pen come into contact with paper, capillary action causes the ink to be supplied. In this case, pen skipping and line splitting hardly occur during writing, so there is an advantage of providing a better writing experience.

Water-based ballpoint pen inks include ink based on dyes and ink based on pigments as main colorants. Dye-based ink has a problem in that water resistance is poor. In addition, when a predetermined period elapses, the low light resistance of the dyes results in a deterioration in the quality of writing lines. Pigment-based ink is excellent in water resistance and light resistance, but the characteristics thereof differ in material, size, specific gravity, and the like depending on the types of pigment. For this reason, each pigment requires different dispersion processes. When matching color by mixing pigments of different colors, especially for obtaining a desired color, there is a problem of a reduction in ink stability due to differences in the characteristics of each pigment. To solve these problems, a variety of inks to which a method of coloring a resin or coating a surface with a pigment is applied have been proposed. Methods using a coated pigment enable good dispersion stability to be obtained and all surfaces to be uniform regardless of color. Therefore, uniform dispersion stability can be achieved during ink manufacturing, and thus the degree of freedom in selecting a mixture can be increased in ink manufacturing.

Such pigments are fine particles and thus subjected to a dispersion process using a solvent to be formed into ink. However, dispersing the pigments in a water-soluble solvent is difficult. For this reason, a technique for manufacturing water-soluble ink through dispersion using a surfactant has been developed to increase pigment affinity. Specifically, Japanese Patent Publication No. 2006-096882 relates to a water-soluble pigment-based ink composition, where ink is manufactured using a polyoxyethylene oleyl cetyl ether sulfate ester ammonium salt as a surfactant. In addition, Japanese Patent No. 4547885 relates to water-soluble ink, where pigment particles are dispersed using a cationic polymerizable surfactant and an anionic polymerizable surfactant. However, in the case of water-soluble inks containing surfactants, the ink becomes concentrated and thickened over time as in the related art, so ink flow fails to be facilitated, resulting in frequent problems that make handwriting difficult.

To solve the problems occurring when directly dispersing a pigment in a surfactant-containing solvent, as described above, a technique for improving pigment dispersibility and the physical properties of ink by pigment coating has been developed. Specifically, in JP-A No. 53-94581, carbon black is coated with a hydrophobic polymer by being dispersed in a hydrophobic vinyl monomer and thermally polymerized. In this case, the surface of the pigment is coated with a solvent-friendly material to increase the affinity with a solvent, thereby improving the dispersibility. However, the most important thing when coating a pigment is to ensure adsorption onto the pigment surface and a stable state in which the coating layer adsorbed from the solvent is not present in a free form. Therefore, there is a growing need for developing new technologies to improve physical properties of the coating layer, ink stability, and pigment dispersibility according to the adsorption of surfactants and coating material.

Hence, the inventors of the present disclosure have made an effort to conduct intensive and thorough research to overcome the problems in the related art. As a result, when preparing a coated pigment using two different types of surfactants as pigment dispersants and two different monomers that differ in glass transition point by a value of at least 50° C. as pigment-coating agents, there were advantages of improving pigment dispersion stability and adsorption stability of a coating layer while controlling hardness and flexibility of the coating layer due to the glass transition point difference. In addition, when using the coated pigment as an ink pigment, it was confirmed that adhesiveness and lubricity was improved while providing a better writing experience. As a result, the present disclosure was completed.

### DOCUMENT OF RELATED ART

### Patent Document

(Patent Document 1) JP 2006-096882 A
(Patent Document 2) JP 4547885 B2

### SUMMARY OF THE INVENTION

Therefore, the main objective of the present disclosure is to provide a method of preparing a coated pigment. Through the preparation method, the adsorption stability during pigment coating can be improved by increasing pigment dispersibility. In addition, when using the coated pigment as an ink pigment, adhesiveness and lubricity can be improved while providing a better writing experience by keeping the strength of the coated pigment from increasing.

Another objective of the present disclosure is to provide a water-based ink composition containing the pigment prepared by the preparation method of the coated pigment and cellulose nanofiber (CNF), which is a thickener.

A further objective of the present disclosure is to provide a water-based writing instrument including the water-based ink composition.

According to one aspect of the present disclosure, the present disclosure provides a method of preparing a coated pigment, which includes: preparing a pigment dispersion by mixing and dispersing first and second surfactants with a pigment in water; and coating the pigment by adding an emulsion obtained by mixing and emulsifying a polymerizable surfactant and first and second monomers that differ in glass transition point, to the pigment dispersion.

Surfactants used as pigment-coating materials for preparing coated pigments in the related art function to increase pigment dispersibility and thus are commonly used. However, these surfactants may rather reduce the dispersibility depending on the types thereof and deteriorate the physical properties of the coated pigment according to combinations of a surfactant and a pigment-coating material. Therefore, it is important to prepare a coated pigment via proper selection and combination of a surfactant and a coating material. Hence, the inventors of the present disclosure screened surfactants and coating materials used for improving the adsorption stability during pigment coating and enhancing the physical 1 properties and functionality of the coated pigment.

In the method of preparing the coated pigment according to the present disclosure, the first surfactant may be at least one selected from the group consisting of a fatty alcohol polyglycol ether sulfate, a sodium polyoxyethylene dodecyl ether sulfate, a polyoxyethylene lauryl ether, a polyoxyethylene phosphate ester, a polyoxyethylene styrenated phenyl ether sulfate ammonium salt, a polyoxyethylene alkyl ether sulfate sodium salt, and a polyoxyethylene oleyl cetyl ether sulfate sodium salt. The first surfactant preferably is alcohol polyglycol ether sulfate, and more the fatty preferably is a polyoxyethylene oleyl cetyl ether sulfate ammonium salt. In addition, the second surfactant is represented by Formula 1.

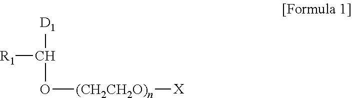

In this case,
R₁ is a functional group having 1 to 18 carbon atoms,
D₁ is

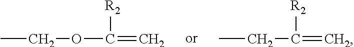

R₂ is H or CH₃,
n is an integer in a range of 10 to 20, and
X is —SO₃M, —COOM, or —PO₃M₂ (where M is an alkali metal atom, alkyl ammonium, alkanol ammonium, or ammonium, and is present in a salt form).

In the method of preparing the coated pigment according to the present disclosure, the second surfactant may be a sulfate-based surfactant and preferably is a polyoxyethylene-1-(allyloxymethyl)alkyl ether ammonium sulfate.

According to one experimental example of the present disclosure, when the fatty alcohol polyglycol ether sulfate and the surfactant according to Formula 1 were used as the first and second surfactants, respectively, pigment dispersibility was increased, so the pigment did not aggregate. However, when other surfactants were used as the second surfactant, dispersibility was reduced, resulting in pigment aggregation (see Experimental Example 1). These results show that proper selection and combination of the surfactants for preparing the pigment dispersion may help improve the dispersibility, prevent pigment aggregation, and thus improve the adsorption stability during pigment coating.

In the method of preparing the coated pigment according to the present disclosure, the first monomer may be represented by Formula 2. In addition, the second monomer may differ from the first monomer in glass transition point by a value in a range of 35° ° C. to 125° C., preferably, 50° C. to 110° C. When the glass transition point difference between the first and second monomers does not fall within the above numerical range, functions of a coating film, such as adhesiveness and flexibility, may be deteriorated, resulting in difficulty when coating the pigment. Alternatively, when applying a water-based ink composition containing the coated pigment to a writing instrument, writing performance may be poor.

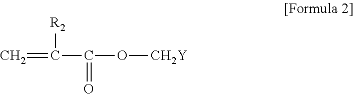

In this case,
R₂ is H or CH₃, and
Y is —CF₃ or

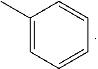

In the method of preparing the coated pigment according to the present disclosure, any monomer containing a fluoroethyl group or a benzyl group may be used. However, the monomer preferably is 2,2,2-trifluoroethyl methacrylate or 2,2,2-benzyl methacrylate.

In the method of preparing the coated pigment according to the present disclosure, any monomer that differs from the first monomer in glass transition point by a value in a range of 35° ° C. to 125° C., preferably, 50° C. to 110° C., may be used as the second monomer. However, the second monomer preferably is any monomer used for providing flexibility and adhesiveness to existing coating films and more preferably is at least one selected from the group consisting of butyl acrylate, ethyl acrylate, methyl methacrylate, styrene, ethyl methacrylate, 2-ethylhexyl acrylate, hexyl methacrylate, and 2-hydroxyethyl acrylate. Most preferably, the second monomer is butyl acrylate or ethyl acrylate.

According to one experimental example of the present disclosure, when combining the second monomer that differs from the first monomer in glass transition point by a value in a range of 50° ° C. to 110° C., the monomer had an excellent adsorption reactivity to the pigment. As a result, the coated pigment was well-prepared. On the contrary, when combining the second monomer that differs from the first monomer in the glass transition point by a value that did not fall within the range of 50° C. to 110° ° C., the monomer had a poor adsorption reactivity to the pigment. As a result, the coated pigment was confirmed to be poorly prepared (see Experimental Example 2). These results show that proper selection and combination of monomers according to the glass transition point difference between the pigment-coating materials may help improve the functionality of the coated pigment by improving the adsorption reactivity of the pigment.

In the method of preparing the coated pigment according to the present disclosure, any surfactant conventionally used to polymerize a coating material to a pigment may be used as the polymerizable surfactant. However, the polymerizable surfactant preferably is a reactive surfactant capable of providing high adhesive strength, and more preferably is at least one reactive surfactant selected from the group consisting of dimethylaminoethyl methacrylate methyl chloride, dimethylaminoethyl methacrylate benzyl chloride, methacryloyloxyethyl trimethyl ammonium chloride, diallyldimethylammonium chloride, and 2-hydroxy-3-methacryloxypropyl trimethyl ammonium chloride.

In the method of preparing the coated pigment according to the present disclosure, a polymerization initiator may be further added in the coating of the pigment. The polymerization initiator may be at least one selected from the group consisting of aromatic ketones, acyl phosphine compounds, aromatic onium salt compounds, organic peroxides, thio compounds, hexaaryl biimidazole compounds, ketoxime ester compounds, borate compounds, azinium compounds, metallocene compounds, active ester compounds, compounds containing a carbon-halogen bond, and alkyl amine compounds. The polymerization initiator preferably is ammonium persulfate but is not limited thereto.

In the method of preparing the coated pigment according to the present disclosure, the pigment is not particularly limited, and any organic or inorganic pigment of any color may be used. The organic pigment may be at least one selected from the group consisting of azo-based pigments, phthalocyanine-based pigments, dye-based pigments, condensed polycyclic-based pigments, quinacridone-based pigments, nitro-based pigments, nitroso-based pigments, carbon black, lamp black, acetylene black, and channel black. The inorganic pigment may be at least one selected from the group consisting of metals, such as cobalt, iron, chromium, copper, zinc, lead, titanium, vanadium, manganese, nickel, and the like, metal oxides, and sulfides.

In the method of preparing the coated pigment according to the present disclosure, other components, such as moisturizers, preservatives, defoamers, pH modifiers, and the like, may be added during the preparation of the coated pigment, but examples thereof are not limited thereto.

According to another aspect of the present disclosure, the present disclosure provides a water-based ink composition containing: a coated pigment prepared by preparing a pigment dispersion by mixing and dispersing first and second surfactants with a pigment in water and coating the pigment by adding an emulsion obtained by mixing and emulsifying a polymerizable surfactant and first and second monomers that differ in glass transition point, to the pigment dispersion; and a thickener.

In the water-based ink composition of the present disclosure, any thickener conventionally used to control the viscoelasticity of the ink may be used. However, the thickener preferably is at least one selected from the group consisting of cross-linked acrylic polymers, xanthan gum, welan gum, succinoglycan, guar gum, locust bean gum, λ-carrageenan gum, cellulose derivatives, diutan gum, associative thickeners, and alkali-swelling thickeners. Most preferably, cellulose nanofiber (CNF) is best suited.

In the water-based ink composition of the present disclosure, the thickener is contained in an amount in a range of 0.05 to 0.5 mass % with respect to the total mass of the water-soluble ink composition. In the case of using xanthan gum or succinoglycan alone as the thickener, pigment sedimentation is likely to occur during heating, so a large amount is required to be added to prevent sedimentation. However, when adding a large amount of the thickener, high viscosity may cause a decrease in handwriting density, and 5 problems, such as line skipping and deterioration in ink followability, may occur. When adding cellulose nanofiber (CNF) to solve these problems, as in the present disclosure, even a small amount thereof may enable a complex network structure to be formed by being combined with the three-dimensional network structure of cellulose without increasing the viscosity more than necessary. Therefore, cellulose nanofiber (CNF) allows a further high pigment dispersibility to be exhibited and thus is best suited. In addition, the water-based ink composition of the present disclosure may be used in combination with a polysaccharide thickener, and the mass ratio of the thickener to CNF is preferably in a range of 1:1 to 6:1.

In the water-based ink composition according to the present disclosure, the ink composition may further contain any other components contained in water-based ink compositions for writing instruments. For example, the ink composition may further contain at least one selected from the group consisting of binders, surfactants, moisturizers, water-soluble organic solvents, water-soluble resins, defoamers, solubilizers, penetration modifiers, viscosity modifiers, pH modifiers, antioxidants, preservatives, corrosion inhibitors, chelating agents, and antiseptics.

According to a further aspect of the present disclosure, the present disclosure provides a water-based writing instrument including a water-based ink composition containing: a coated pigment prepared by preparing a pigment dispersion by mixing and dispersing first and second surfactants with a pigment in water and coating the pigment by adding an emulsion obtained by mixing and emulsifying a polymerizable surfactant and first and second monomers that differ in glass transition point, to the pigment dispersion; and a thickener.

The term “writing instrument” of the present disclosure is a tool that performs functions of writing, painting, drawing, and the like using ink, and includes ballpoint pens, gel ink pens, felt-tip pens, brush pens, and the like. Preferably, the writing instrument is a water-based ballpoint pen.

As described above, when preparing a coated pigment using two different types of surfactants as pigment dispersants and two different types of monomers that differ in glass transition point by a value of at least 50° C. as pigment coating agents, there are advantages of improving pigment dispersion stability and adsorption stability of a coating layer while controlling hardness and flexibility of the coating layer due to the glass transition point difference. In addition, when using the coated pigment as a water-based ink pigment, especially an ink pigment for a water-based ballpoint pen, adhesiveness and lubricity can be improved while providing a better writing experience by keeping the strength of the coated pigment from increasing.

### DESCRIPTION OF THE PREFERRED EMBODIMENTS

Hereinafter, the present disclosure will be described in more detail through examples. These examples are intended to illustrate the present disclosure only, so the scope of the present disclosure is not to be construed as being limited by these examples.

### Example 1: Preparation of Pigment Dispersion

A pigment dispersion was prepared using components shown in Table 1. A specific method is as follows. The water-based pigment dispersion of the present disclosure may be finely dispersed using a wet dispersion technique. The components, other than the pigment, in the composition below dissolved in water. Then, the pigment was added for mixing and stirring using a stirrer. The dispersion was dispersed for about 6 hours using a bead mill (KODOBUKI UAM-150), and then large particles were removed using a centrifuge to obtain the water-based pigment dispersion (dispersion).

TABLE 1

| Example 1 | Content (wt %) |
|---|---|
| Pigment (Pigment red 150) | 35 |
| First surfactant (fatty alcohol | 5.59 |
| polyglycol ether sulfate) | |
| Second surfactant (Formula 1) | 5.36 |
| Moisturizer | 10.0 |
| Preservative | 1.0 |
| pH modifier | 1.0 |
| Defoamer | 0.3 |
| Ion-exchanged water | Remainder |

### Comparative Examples 1 and 2: Preparation of Pigment Dispersion

Pigment dispersions were prepared in the same manner as in Example 1, except for using either sodium dodecyl sulfate (Comparative Example 1, anionic surfactant) or PEO nonyl phenyl ether (Comparative Example 2, nonionic surfactant) as the second surfactant.

### Experimental Example 1: Examination of Characteristics of Pigment Dispersion

The characteristics of the pigment dispersions, prepared in Example 1 and Comparative Examples 1 and 2, were examined. Specific methods of evaluating the pigment dispersions are as follows. The particle diameter was measured using a DLS particle size analyzer (Nanotrac Flex purchased from Microtrac). The particle diameter size is preferably in the range of 100 to 200 nm. The zeta potential (mV) was measured using a Malvern Zetasizer (Nano-ZS90). The greater the absolute value, preferably in the range of −50 to −100 mV, the better the dispersion. As for a microscope, a general optical microscope, Olympus BX53X, was used to evaluate the degree of dispersion. The filtering characteristics of the prepared water-based dispersion were examined using a quantitative filter paper NO.5C (1 μm) purchased from ADVANTEC to confirm whether the pigment dispersion was filtered. The results thereof are shown in Table 2.

TABLE 2

| | | Comparative | Comparative |
|---|---|---|---|
| | Example 1 | Example 1 | Example 2 |
| Size (D50, nm) | 155 | 295 | Aggregate |
| Zeta potential (mV) | −50 | −10 | −15 |
| Microscope | ◯ | X | X |
| Filter (5C) | ◯ | X | X |

As a result of the analysis, in the case of Example 1, the pigment dispersion had a particle size of 155 nm and an absolute zeta potential value of 50, as seen in Table 2. When observed with the microscope, the degree of dispersion was uniform, and factors such as sedimentation, discharge, and flow interruption were not found, confirming that the pigment dispersion was well-filtered. On the contrary, the pigment dispersions of Comparative Examples 1 and 2 had particle sizes and zeta potential values that did not fall within the appropriate range. In addition, when observed with the microscope, not only the degree of dispersion was not uniform, but also the pigment dispersions failed to be filtered due to factors such as sedimentation, and discharge, flow interruption.

### Examples 2 and 3: Preparation of Coated Pigment

Coated pigments were prepared by selecting two types of monomers that differed in glass transition point by a value in a range of 50° C. to 110° C. and adding the monomers to the pigment dispersion prepared in Example 1, as shown in Table 3. A specific method is as follows. Specifically, ammonium persulfate and a pH modifier were added to the pigment dispersion (dispersion). Then, an emulsion was added dropwise to the monomer and mixed with stirring. Even though monomer microparticles (emulsion) of the pigment dispersion were dispersed in water immediately after dropwise addition, when being stirred for 30 minutes after the completion of dropwise addition, all the monomer particles of the emulsion were well-adsorbed and thus were not visually observed. Then, the resulting pigment dispersion was heated to raise a temperature to 70° C., and the same temperature was maintained for 4 to 5 hours with stirring. Lastly, a filtering process (using NO.5C) was performed.

TABLE 3

| | Example 2 | Example 3 |
|---|---|---|
| Pigment dispersion of Example 1 | 399.08 | 399.08 |
| (water-based dispersion) | | |
| Moisturizer | 20.0 | 20.0 |
| pH Modifier | 10.0 | 10.0 |
| Ammonium persulfate | 6.0 | 6.0 |
| First monomer (2,2,2-trifluoroethyl | 16.0 | — |
| methacrylate having a Tg of 5° C.) | | |
| First monomer (benzyl methacrylate | — | 16.0 |
| having a Tg of 54° C.) | | |
| Second monomer (butyl acrylate | 16.0 | 16.0 |
| having a Tg of −55° C.) | | |
| Emulsifier | 6.0 | 6.0 |
| Ion-exchanged water | 60 | 60 |
| ΔTg (° C.) | 50 | 109 |

### Comparative Examples 3 and 4: Preparation of Coated Pigment

Coated pigments were prepared in the same manner as in Examples 2 and 3, except that two types of monomers were selected as shown in Table 4 to differ in glass transition point by a value of less than 50° C. A specific method is as follows.

TABLE 4

| | Comparative | Comparative |
|---|---|---|
| | Example 3 | Example 4 |
| Pigment dispersion of Example 1 | 399.08 | 399.08 |
| (water-based dispersion) | | |
| Moisturizer | 20.0 | 20.0 |
| pH Modifier | 10.0 | 10.0 |
| Ammonium persulfate | 6.0 | 6.0 |
| First monomer (2,2,2-trifluoroethyl | 16.0 | — |
| methacrylate having a Tg of 5° C.) | | |
| First monomer (benzyl methacrylate | — | 16.0 |
| having a Tg of 54° C.) | | |
| Second monomer (ethyl acrylate | 16.0 | — |
| having a Tg of 22° C.) | | |
| Second monomer (ethyl methacrylate | — | 16.0 |
| having a Tg of 65° C.) | | |
| Emulsifier | 6.0 | 6.0 |
| Ion-exchanged water | 60 | 60 |
| ΔTg (° C.) | 27 | 11 |

### Experimental Example 2: Examination of Characteristics of Coated Pigment

The characteristics of the coated pigments, prepared in Examples 2 and 3 and Comparative Examples 3 and 4, were examined. Specifically, whether the monomer emulsion was absorbed and the dispersibility were confirmed with an optical microscope (Olympus BX53X) at a magnification of 200× for the coated pigment obtained by solution polymerization. In addition, filtering performance was examined using a quantitative filter paper NO.5C (1 μm) purchased from ADVANTEC. The results thereof are shown in Table 5.

TABLE 5

| | | | Comparative | Comparative |
|---|---|---|---|---|
| | Example 2 | Example 3 | Example 3 | Example 4 |
| Microscope | ◯ | ◯ | Δ | Δ |
| Filter (5C) | ◯ | ◯ | X | X |

As a result of the analysis, in the case of Examples 2 and 3, the monomer emulsions were well-adsorbed and thus not visually observed, as seen in Table 5. However, in the case of Comparative Examples 3 and 4, the monomer emulsions were observed to remain in the form of an emulsion solution in the dispersion. In addition, in the case of Examples 2 and 3, the coated pigment solutions passed through the 5 C filter and thus were well-filtered. However, in the case of Comparative Examples 3 and 4, the coated pigment solutions failed to be filtered and thus were clogged. This causes unreacted substances to remain in the dispersion and react when preparing an ink composition, or causes problems in writing performance.

### Examples 4 and 5: Preparation of Water-Based Ink Composition and Preparation of Ballpoint Pen Containing Same Composition

Water-based inks (Table 6) containing CNF as a thickener and either of the coated pigments, prepared in Examples 2 and 3, were manufactured (numerical values in Table 6 represent parts by mass). Specifically, CNF was stirred with polysaccharide gum under high shear force for about 1 hour to prepare a pre-gel form. Subsequently, after adding the remaining components, the coated pigment was added. Then, the resulting product was uniformly mixed and stirred using a disperser to prepare an ink composition for a water-based ballpoint pen.

TABLE 6

| | Example 4 | Example 5 |
|---|---|---|
| Coated pigment (Example 2) | 30 | — |
| Coated pigment (Example 3) | — | 30 |
| Xanthan gum (Gelzan) | 0.3 | 0.3 |
| CNF (Rheocrysta I-2SP) | 0.05 | 0.05 |
| Prysurf A208B | 1.0 | 1.0 |
| Preservative (XL-2) | 0.2 | 0.2 |
| TEA | 0.5 | 0.5 |
| Glycerine | 10 | 10 |
| Ion-exchanged water | Remainder | Remainder |

An ink container made of PP resin was filled with each ink composition prepared above and then connected with a @ 0.5-mm tip and a holder to manufacture a refill.

### Comparative Examples 5 and 6: Preparation of Water-Based Ink Composition and Preparation of Ballpoint Pen Containing Same Composition

Water-based inks (Table 7) containing CNF as a thickener and either of the coated pigments, prepared in Examples 2 and 3, were manufactured in the same manner as in Examples 4 and 5 (numerical values in Table 7 represent parts by mass).

TABLE 7

| | | Comparative | Comparative |
|---|---|---|---|
| | | Example 5 | Example 6 |
| Coated pigment (Example 2) | | 30 | — |
| Coated pigment (Example 3) | | — | 30 |
| Thickener | Succinoglycan | 0.23 | — |
| | (Rheozan) | | |
| | Polyacrylic acid | — | 0.3 |
| | (HW-104) | | |

| | | |
|---|---|---|
| Prysurf A208B | 1.0 | 1.0 |
| Preservative (XL-2) | 0.2 | 0.2 |
| TEA | 0.5 | 0.5 |
| Glycerine | 10 | 10 |
| Ion-exchanged water | Remainder | Remainder |

An ink container made of PP resin was filled with each ink composition prepared above and then connected with a @ 0.5-mm tip and a holder to manufacture a refill.

### Experimental Example 3: Examination of Water-Based Ink Viscosity

The viscosity of the water-based inks manufactured in Examples 4 and 5 and Comparative Examples 5 and 6 was measured at 20° C. using a rotational viscometer (Brookfield viscometer DV2T) at 6 rpm and 60 rpm. The results thereof are shown in Table 8.

TABLE 8

| | Example | Example | Comparative | Comparative |
|---|---|---|---|---|
| | 4 | 5 | Example 5 | Example 6 |
| Viscosity at | 2120 | 2000 | 2500 | 3500 |
| 20° C. and 6 rpm | | | | |
| at 20° C. and 60 | 390 | 386 | 460 | 570 |
| rpm | | | | |

As a result of the analysis, since the thickener is used in all Examples 4 and 5 and Comparative Examples 5 and 6, as seen in Table 8, thixotropy, that is, a phenomenon in which viscosity decreases when shear force acts and increases when shear force does not act, is observed. In addition, the measurement value of ink viscosity is suitably in a range of 1500 to 2500 mPa·s at 6 rpm because there is a concern that when the ink viscosity exceeds 2500 mPa·s, excessive force is needed for writing while ink followability or the dry-out characteristic of a nib deteriorates, resulting in skipping during writing. From this point of view, the viscosity of the ink, according to the present disclosure, is suitable for use as a composition for a water-based ballpoint pen.

### Experimental Example 4: Examination of Ink Stability and Evaluation of Writing Experience

The ink stability and writing experience of ballpoint pens containing either of the water-based inks, manufactured in Examples 4 and 5 and Comparative Examples 5 and 6, were examined.

Specifically, for the ink stability evaluation, the tip of the ballpoint pen refill stood still to be faced downward and left for 90 days under a condition at a temperature of 50° C. Then, ink conditions (layer separation, sedimentation, aggregation, viscosity, and the like) in the refill were examined with the naked eye and then observed with a microscope at room temperature. In addition, for the writing experience, ISO14145-1 standard writing test was performed on each sample using a writing tester (HUTT HT10). Then, the ball abrasion was measured using a microscope (Mitutoyo TOOLMAKER'S microscope having a 50× magnification). The results thereof are shown in Table 9.

TABLE 9

| | | Example | Example | Comparative | Comparative |
|---|---|---|---|---|---|
| | | 4 | 5 | Example 5 | Example 6 |
| Ink stability (at | | ◯ | ◯ | Δ | X |
| 50° C. for 9 Weeks) | | | | | (aggregate) |
| Writing | Writing | ◯ | ◯ | ◯ | X |
| test | line | | | | |
| | skipping | | | | |
| | Writing | ◯ | ◯ | X | X |
| | line | | | | |
| | clogging | | | | |
| | Ball | 10 | 11 | 25 | — |
| | abrasion | | | | |
| | (Fm) | | | | |

As a result of the analysis, the inks manufactured in Examples 4 and 5, using cellulose nanofiber, were excellent in the ink stability, as confirmed in Table 9, without ink precipitation, separation, or aggregation over time. On the contrary, in the case of using the polysaccharide alone, ink precipitation, separation, aggregation, and the like were observed over time. Even when performing the writing test on the refills manufactured in Examples 4 and 5, good handwriting and excellent TIP lubricity were shown until the completion of the test.

What is claimed is:

1. A method of preparing a coated pigment, the method comprising:
preparing a pigment dispersion by mixing and dispersing first and second surfactants with a pigment in water; and
coating the pigment by adding an emulsion obtained by mixing and emulsifying a polymerizable surfactant and first and second monomers that differ in glass transition point, to the pigment dispersion.

2. The method of claim 1, wherein the first surfactant is a fatty alcohol polyglycol ether sulfate, and
the second surfactant is represented by Formula 1, 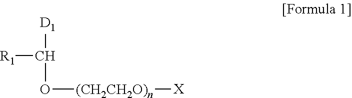
wherein R₁ is a functional group having 1 to 18 carbon atoms,
D₁ is 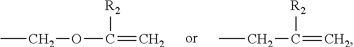
n is an integer in a range of 10 to 20, and
X is —SO₃M, —COOM, or —PO₃M₂ (where M is an alkali metal atom, alkyl ammonium, alkanol ammonium, or ammonium, and is present in a salt form).

3. The method of claim 2, wherein the second surfactant is a polyoxyethylene-1-(allyloxymethyl)alkyl ether ammonium sulfate.

4. The method of claim 1, wherein the first monomer is represented by Formula 2, and
the second monomer differs from the first monomer in a glass transition point by a value in a range of 50° C. to 110° C., 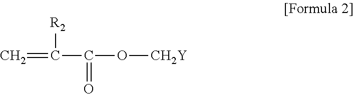
wherein R₂ is H or CH₃, and
Y is —CF₃ or

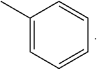

5. The method of claim 4, wherein the first monomer is 2,2,2-trifluoroethyl methacrylate or 2,2,2-benzyl methacrylate.

6. The method of claim 4, wherein the second monomer is butyl acrylate or ethyl acrylate.

7. The method of claim 1, wherein the polymerizable surfactant is at least one reactive surfactant selected from the group consisting of dimethylaminoethyl methacrylate methyl chloride, dimethylaminoethyl methacrylate benzyl chloride, methacryloyloxyethyl trimethyl ammonium chloride, diallyldimethylammonium chloride, and 2-hydroxy-3-methacryloxypropyl trimethyl ammonium chloride.

8. A water-based ink composition comprising:
the coated pigment prepared according to claim 1; and
a thickener.

9. The ink composition of claim 8, wherein the thickener is a cellulose nanofiber (CNF).

10. The ink composition of claim 8, wherein the ink composition has a viscosity in a range of 1500 mPa·s to 2500 mPa·s when being measured using a DV2T viscometer at a temperature of 20° C. and a rotation speed of 6 rpm.

11. A water-based writing instrument comprising the water-based ink composition of claim 8.
